(19) United States
(12) Patent Application Publication
(10) Pub. No.: US 2002/0104552 A1
(43) Pub. Date: Aug. 8, 2002

(54) Systems and methods for forming processing streams

(76) Inventors: Steven Bay, Downingtown, PA (US); Roger Kaiser JR., West Grove, PA (US)

Correspondence Address: Woodcock Washburn Kurtz, Mackiewicz & Norris LLP, 46th Floor, One Liberty Place, Philadelphia, PA, 19103, US

(21) Appl. No.: 09/930,009

(22) Filed: Aug. 15, 2001

Related U.S. Application Data
(60) Provisional application No. 60/225,875, filed on Aug. 17, 2000.

(51) Int. Cl. B08B 3/00

(52) U.S. Cl. 134/18; 134/36; 134/100.1; 134/56 R

(57) ABSTRACT

Systems and methods for processing electronic components having a vessel for holding electronic components and a carrier supply system operatively associated with the vessel for supplying a carrier stream to the vessel. An injection system is in fluid communication with the carrier supply system for introducing a process solution into the carrier supply system and a processor is operatively associated with the injection system. The processor generates data for process solution volume and injection pressure associated with the injection system and carrier stream flow rate associated with the carrier supply system as a function of time. A process solution injection rate as a function of process solution volume, injection pressure, and carrier stream flow rate is determined. Values for the injection pressure and the carrier stream flow rate for a predetermined process solution injection rate are the determined. The processor then controls injection of the process solution from the injection system into the carrier supply system at the predetermined process solution injection rate by adjusting the injection pressure and the carrier stream flow rate to the determined values.

This application claims benefit of U.S. Provisional Application Ser. No. 60/225,875, filed Aug. 17, 2000.

### FIELD OF THE INVENTION

The present invention relates to systems and methods for processing electronic components. In particular, the present invention relates to systems and methods for forming processing streams used to process electronic components, such as semiconductor substrates.

### BACKGROUND OF THE INVENTION

Wet processing of semiconductor substrates, such as wafers, flat panels, and other electronic component precursors is used extensively during the manufacture of, for example, integrated circuits. Preferably, wet processing is carried out to prepare the semiconductor substrates for processing steps such as diffusion, oxidation, ion implantation, epitaxial growth, chemical vapor deposition, and hemispherical silicon grain growth, or combinations thereof. During wet processing, the semiconductor substrates are contacted with a series of process solutions. The process solutions may be used, for example, to etch, to remove photoresist, to clean, or to rinse the semiconductor substrates. See, e.g., U.S. Pat. Nos. 4,577,650; 4,740,249; 4,738,272; 4,856,544; 4,633,893; 4,778,532; 4,917,123; and EPO 0 233 184, assigned to a common assignee, and Burkman et al, Wet Chemical Processes-Aqueous Cleaning Processes, pg 111-151 in Handbook of Semiconductor Wafer Cleaning Technology (edited by Werner Kern, Published by Noyes Publication Parkridge, New Jersey 1993), the disclosures of which are herein incorporated by reference in their entirety.

There are various types of systems available for wet processing. For example, the semiconductor substrates may be processed in a single vessel system closed to the environment (such as a Full-Flow™ system supplied by CFM Technologies), a single vessel system open to the environment, a multiple open bath system (e.g., wet bench) having a plurality of baths open to the atmosphere, or a spin-spray system.

Following processing, the semiconductor substrates are typically dried. Drying of the semiconductor substrates can be done using various methods, with the goal being to ensure that there is no contamination created during the drying process. Methods of drying include evaporation, centrifugal force in a spin-rinser-dryer, steam or chemical drying of wafers, including the method and apparatus disclosed in, for example, U.S. Pat. Nos. 4,778,532 and 4,911,761.

A common problem encountered in the wet processing of semiconductor substrates is obtaining repeatable processing results (i.e. process control) for all surfaces of a single semiconductor substrate, between semiconductor substrates in a single batch, and between batches of semiconductor substrates that are processed in the same manner. For example, when semiconductor wafers are etched to remove oxides, it is desirable that the thickness of etching is substantially the same on all surfaces of a single wafer, as well as between wafers within the same batch. Additionally, it is desired that wafers in different batches being processed under the same etching conditions do not vary substantially in the amount etched (i.e., batch to batch variation).

Traditionally, process control in semiconductor wet processing is completed through the use of “monitor semiconductor substrates.” Monitor semiconductor substrates are processed in the equipment using the same manufacturing conditions as the production semiconductor substrates. The monitor semiconductor substrates are then tested to ensure that the manufacturing process is running within its specified limits. However, the use of monitor semiconductor substrates can be costly. For example, the use of monitor semiconductor substrates leads to lost production time as well as wasted raw materials in processing the monitor semiconductor substrates.

One way to eliminate or reduce the use of monitor semiconductor substrates is to monitor processing conditions in the processing vessel and make adjustments to the processing conditions during processing. For example in an etching process for semiconductor substrates, it is known that etching thickness is a function of etching time, temperature, and chemical concentration of the etching agent. Also for example, in cleaning processes, such variables as cleaning time, temperature, use of megasonic energy, and chemical concentration can have an impact on the uniformity and efficiency of cleaning of the semiconductor substrates. Thus, processing results can be controlled through such parameters as temperature, chemical concentration, and processing time. While solution temperature and processing time can readily be controlled in most wet processing systems, the measuring and controlling of chemical concentrations has been problematic. Thus, much effort has focused on developing systems and methods for determining chemical concentrations for improved process control in wet processing systems.

For example, in U.S. Pat. No. 5,472,516 to Hanson et al., (“Hanson”) a control strategy is proposed for measuring and maintaining the concentration of chemicals in a bath. In Hanson, the concentrations of ammonium hydroxide and hydrogen peroxide in an APM cleaning solution were monitored by measuring the pH and conductivity of the APM cleaning. The conductivity was used to control the addition of ammonia to the bath, and the pH was used to control the addition of hydrogen peroxide to the bath. The process extended the life of the APM solution. IR spectrometric monitors have also been used to monitor chemical concentrations in open bath systems.

In open bath systems such as the system used by Hanson, monitoring instruments may be readily placed within the bath in-situ, providing the user with real-time chemical concentration information. However, even in an open bath system, in-situ sensors, may not accurately measure chemical concentrations. For example, when there is more than one chemical present, one may not be able to accurately measure the concentration of a chemical (such as a weak acid or base) due to the presence or interaction of other chemicals (such as a strong acid or strong base) present in the bath. Often, more than one monitor may be needed to measure the concentrations of different chemicals, leading to increased costs for purchasing and maintaining the monitors, such as in Hanson. Equipment for measuring concentrations directly, such as conductivity meters, can also be unreliable.

Determining and controlling chemical concentrations in a single pass wet processing vessel (where a solution is passed once through the vessel) can be further problematic. For example, in many single pass wet processing vessels, the placement of a concentration measuring device in the vessel will disrupt the flow pattern of process solution resulting in nonuniform contacting of the process solution with the semiconductor substrates. A solution would be to place the measuring devices upstream or downstream of the process vessel. However, when the process solution contains mixtures of chemicals, more than one measuring device will most likely be needed, leading to increased costs for purchasing and maintaining several measuring devices. Additionally, it may not even be possible to accurately measure the concentration of each chemical in the process solution due to interactions between the chemicals or equipment reliability problems.

Thus, there is a need for simpler systems and methods for determining and controlling chemical concentrations of processing streams used in a wet processing system. The systems and methods should improve process reliability by preventing delivery of a chemical mixture to a process vessel that is significantly different from the desired chemical ratios. In addition, the systems and methods should be automatable.

### SUMMARY OF THE INVENTION

In one of its aspects, the present invention relates to a system for processing electronic components comprising a vessel for holding electronic components and a carrier supply system operatively associated with the vessel for supplying a carrier stream to the vessel. An injection system is provided in fluid communication with the carrier supply system for introducing a process solution into the carrier supply system. In one embodiment, the injection system comprises one or more reservoirs or injection tubes for storing one or more process solutions and injecting said process solutions into the carrier supply system. The injection system also optionally comprises a valve positioned between the injection tubes or reservoirs and the carrier supply system for adjusting the flow rate of the process solutions from the injection tubes or reservoirs. A processor is operatively associated with the injection system. When the injection system comprises multiple injection tubes or reservoirs, the processor is operatively associated with the injection tubes or reservoirs for individually adjusting an injection rate associated with each of the injection tubes or reservoirs. The processor generates data for process solution volume and injection pressure associated with the injection system and carrier stream flow rate associated with the carrier supply system as a function of time; determines a process solution injection rate as a function of process solution volume, injection pressure, and carrier stream flow rate; determines values for the injection pressure and the carrier stream flow rate for a predetermined process solution injection rate; and injects the process solution from the injection system into the carrier supply system at the predetermined process solution injection rate by adjusting the injection pressure and the carrier stream flow rate to the determined values. When the injection system comprises valves for adjusting the flow rates of the process solutions, the processor is optionally operatively associated with the valves for automatically adjusting the valves.

In another of its aspects, the present invention relates to methods for processing electronic components comprising the step of generating data for process solution volume, injection pressure, and/or injection control valve position associated with an injection system and carrier stream flow rate associated with a carrier supply system as a function of time. A process solution injection rate is then determined as a function of process solution volume, injection pressure, injection control valve position and carrier stream flow rate. Values for the injection pressure, the injection control valve position and/or the carrier stream flow rate are then determined for a predetermined process solution injection rate. The process solution is then injected from the injection system into the carrier stream system at the predetermined process solution injection rate by adjusting the injection pressure, the injection control valve position and/or the carrier stream flow rate to the determined values.

Additional features and embodiments of the present invention will become apparent to those skilled in the art in view of the ensuing disclosure and appended claims.

### Brief Description Of The Drawings

The numerous objects and advantages of the present invention may be better understood by those skilled in the art by reference to the accompanying detailed description and the following drawings, in which:

FIG. 1 is a schematic view of an embodiment of a system for controlling the wet processing of electronic components in accordance with the present invention;

FIG. 2 shows the volume of hydrogen peroxide (H₂O₂) in gallons as a function of time in minutes determined from level-time-pressure data in accordance with the present invention;

FIG. 3 shows measured values of the nitrogen injection pressure in PSIG as a function of time in minutes;

FIG. 4 shows the hydrogen peroxide injection rate in GPM as a function of nitrogen pressure in PSIG at a DI flow rate of 13 GPM determined from the data from FIGS. 2 and 3 in accordance with the present invention; and

FIG. 5 shows the hydrogen peroxide injection rate in GPM as a function of nitrogen pressure in PSIG at DI flow rates of 5, 9, 13, 17 and 21 GPM.

### DETAILED DESCRIPTION OF THE INVENTION

The present invention provides systems and methods for forming a processing stream from a fluid carrier stream and one or more process solutions having known concentrations of process chemicals. The concentration of process chemicals in the processing stream are adjusted by controlling the injection rates of the process solutions and the flow rate of the carrier stream when the process solutions are being combined with the carrier stream to form the processing stream. In this manner, chemical concentrations in the processing stream do not need to be directly measured (although they could still be through such equipment as conductivity meters in the processing stream during wet processing).

The systems and methods of the present invention are particularly useful for controlling the wet processing of semiconductor substrates. In particular, the systems and methods of the present invention are useful in any wet processing procedure for semiconductor substrates where a processing stream containing one or more process chemicals is required. By “wet processing” it is meant that the semiconductor substrates are contacted with one or more processing streams to process the semiconductor substrate in a desired manner. “Wet processing” as defined herein may include for example treating, rinsing, or drying the semiconductor substrates. Typically, such wet processing is carried out to prepare the semiconductor substrate for processing steps such as diffusion, ion implantation, oxidation, epitaxial growth, chemical vapor deposition, hemispherical silicon grain growth, or combinations thereof.

By “processing stream” it is meant any fluid carrier stream used during wet processing that is contacted with the semiconductor substrate and contains one or more process chemicals. By “chemical” or “chemicals” it is meant any agent in a processing stream used to aid in processing (e.g., treat or rinse) semiconductor substrates.

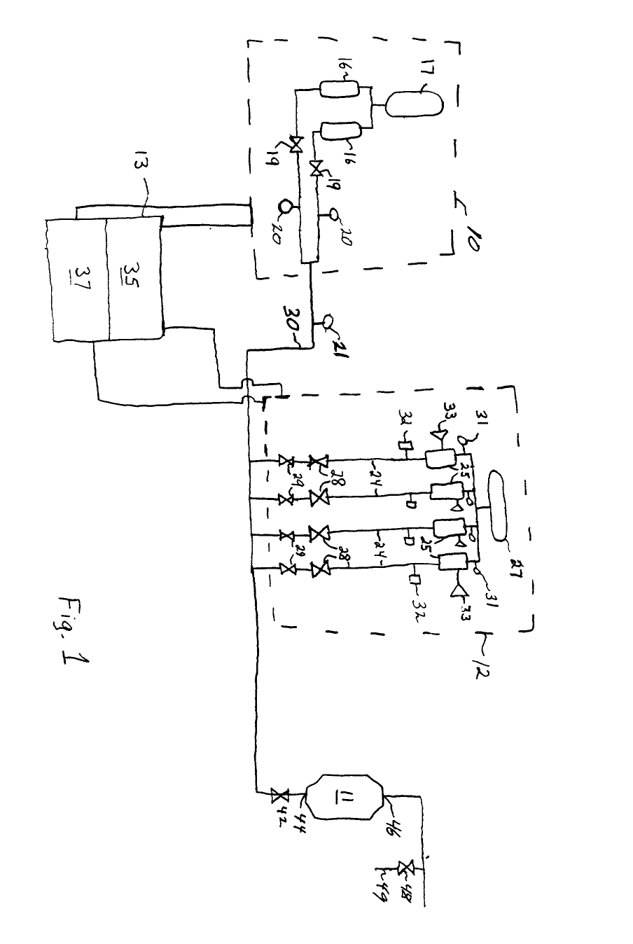

A wet processing system for forming processing streams in accordance with the present invention is shown schematically in FIG. 1. The wet processing system of FIG. 1 comprises a carrier supply system 10 operatively associated with a processing vessel 11 for supplying a carrier stream to the processing vessel 11. An injection system 12 is provided in fluid communication with the carrier supply system 10 for injecting one or more process solutions into the carrier stream. The wet processing system also comprises a processor 13 associated with the injection system 12 and the carrier supply system 10 for adjusting the rate at which the process solutions are injected into the carrier stream.

Process vessels 11 useful in the present invention include any receptacle capable of contacting one or more semiconductor substrates located in the vessel (i.e., a batch) with a processing stream. Suitable process vessels include for example single vessel systems, multiple vessel systems, and spray cleaning systems. See, e.g., Chapter 1: Overview and Evolution of Semiconductor Wafer Contamination and Cleaning Technology by Werner Kern and Chapter 3: Aqueous Cleaning Processes by Don C. Burkman, Donald Deal, Donald C. Grant, and Charlie A. Peterson in Handbook of Semiconductor Wafer Cleaning Technology (edited by Werner Kern, published by Noyes Publication Parkridge, New Jersey 1993), Wet Etch Cleaning by Hiroyuki Horiki and Takao Nakazawa in Ultraclean Technology Handbook, Volume 1, (edited by Tadahiro Ohmi, published by Marcel Dekker), and U.S. Pat. No. 5,656,097 to Olesen et. al., the disclosures of which are herein incorporated by reference in their entireties.

In a preferred embodiment of the invention, the semiconductor substrates are housed in a single process vessel. Additionally, the single process vessel is preferably operated such that the processing stream only passes one time through the process vessel (i.e., a single pass process vessel). In this manner, the concentration of chemicals in the processing stream can be more accurately maintained throughout the time that the processing stream contacts the semiconductor substrates. Preferable, single vessel systems include those disclosed in U.S. Pat. Nos. 4,778,532; 4,917,123; 4,911,761; 4,795,497; 4,899,767; 4,984,597; 4,633,893; 4,917,123; 4,738,272; and 4,577,650, the disclosures of which are herein incorporated by reference in their entireties. Preferred commercially available single vessel systems are Full-Flow™ vessels such as those manufactured by CFM Technologies. Such systems are preferred because the design readily allows for a sequence of processing streams to be passed once through the vessel to process a batch of semiconductor substrates.

The carrier supply system 10 is any type of equipment that can provide one or more carrier streams to the processing vessel 11 at a controlled flow rate. In one embodiment, the carrier supply system 10 comprises any of a variety of conventional sources for flowing degassified deionized water. In the embodiment of FIG. 1, the carrier supply system 10 includes tanks or containers 16 equipped with pressurized gas 17 for holding and directing carrier streams to the processing vessel 11. The carrier supply system 10 also optionally includes pumps (not shown) to deliver the carrier streams to the processing vessel 11. Because wet processes often use processing streams formed using different carrier streams, the carrier supply system 10 of the present invention optionally comprises two or more tanks 16 for holding different carrier streams. In the embodiment shown in FIG. 1, two tanks 16 are provided.

The carrier supply system 10 also comprises carrier stream control valves 19 for adjusting the flow rates of the carrier streams. Preferably, the carrier supply system 10 is capable of providing carrier streams to the processing vessel 11 wherein the variation in flow rate, at fixed positions of the carrier stream control valves 19, is less than about 1 percent and more preferably wherein the variation is less than about 0.5 percent. Accordingly, flow meters 20 are preferably included to provide feedback for controlling the position of valves 19, that is, the flow rate data for the carrier stream is determined by the flow meters 20, sent to processor 13 and used to adjust the position of valves 19.

The flow meters 20 are provided for monitoring the flow rate of the carrier stream as the carrier stream exits the carrier supply system 10 in line 30. Although a variety of conventional flow meters are useful in the present invention, the flow meter 20 is preferably useful for measuring the instantaneous (or real-time) flow rate of the carrier stream. By “instantaneous” it is meant that there is preferably substantially no delay between the flow measurement and the availability of the measurement for further use. Suitable equipment for measuring the flow rate of the carrier stream includes, for example, level probes, paddle wheel flow meters, ultrasonic flow meters, vortex flow meters, rotometers or magnetic flow meters. The flow rates obtained from the flow meter may be, for example, mass flow rates or volumetric flow rates. Preferably the flow meter 20 chosen has a percent error of about 1 percent or less, and more preferably about 0.2 percent or less. The most preferred equipment for measuring the flow rate of the carrier stream are ultrasonic time of flight flow meters.

If two tanks 16 are supplied, they are usually for a hot and a cold water supply system. In that case, the flow meters 20, in conjunction with valves 19, are used to blend an appropriate water flow rate and water temperature. A temperature meter 21 can be used to monitor the temperature of the carrier stream in line 30.

The carrier supply system 10 may also optionally be equipped with degasification equipment to degasify the carrier stream prior to introduction into the process vessel 11. Further, when the carrier stream is deionized water, the carrier supply system 10 may also have equipment for deionizing water such as ion exchange columns.

The carrier stream is preferably a solvent that is compatible with the process chemicals being used and delivers the process chemicals to the surfaces of the semiconductor substrates for treatment. The carrier stream may also be used during wet processing as a rinsing solution. A preferred carrier stream is deionized water. Other carrier streams include for example organic solvents, mixtures of organic solvents, mixtures of organic solvents and water, ozonated water, inorganic solvents, mixtures of inorganic solvents, mixtures of inorganic solvents and water, or combinations thereof. Suitable organic solvents include alcohols such as methanol, ethanol, 1-propanol, isopropanol, n-butanol, secbutanol, tertbutanol, or tert-amyl alcohol, acetone, acetonitrile, hexafluoroacetone, nitromethane, acetic acid, propionic acid, ethylene glycol mono-methyl ether, difluoroethane, ethyl acetate, isopropyl acetate, 1,1,2-trichloro-1,2,2-trifluoroethane, 1,2-dichloroethane, trichloroethane, perfluoro-2-butyltetrahydrofuran, perfluoro- 1,4-dimethylcyclohexane or combinations thereof. Preferable organic solvents are C₁ to C₆ alcohols, such as for example methanol, ethanol, 1-propanol, isopropanol, n-butanol, secbutanol, tertbutanol, tert-amyl alcohol, pentanol, hexanol or combinations thereof.

The injection system 12 useful in the present invention is any type of system capable of injecting one or more process solutions into the carrier stream carried in line 30 at a controlled rate to form a processing stream. In a preferred embodiment, the injection system 12 includes an injection manifold for combining one or more process solutions with the carrier stream via one or more injection lines 24. An injection tube 25 is provided for each of the one or more process solutions. The process solutions can be a single chemical solution or a solution containing a mixture of chemicals. Each of the injection tubes 25 is operatively associated with a gas source 27, such as a source of nitrogen (N2) gas, so that gas from the gas source 27 can be supplied to the injection tube 25 to create a column of gas that can be used to expel the process solution from the injection tube 25. Accordingly, the flow rate of the process solution can be controlled by adjusting the pressure of the column of gas within the injection tubes 25 (i.e., the injection pressures). Injection range valves 28, such as conventional needle valves, are optionally provided between the injection tubes 25 and a carrier stream line 30 for further adjusting the available range of injection rates of the process solutions into the carrier stream. Alternatively, a fixed orifice may be used to provide a fixed range of injection rates. A pressure regulator 31 is preferably used with each injection tube 25 to control the gas pressure and a pressure gauge 32 is optionally provided on each of the injection tubes 25 to measure the injection pressures. Preferably, the injection system 12 has control valves 29 on each injection line 24 that are either opened or closed to permit flow of a particular process solution into the carrier stream in line 30. The control valves 29 can be monitored and controlled by the processor 13.

The injection system 12 comprises any of a variety of conventional sensors 33 for detecting the level of the process solution within each of the injection tubes 25. In one embodiment, the sensors 33 are full-length capacitance level sensors. It will be appreciated that the range of injection pressures required to obtain a sufficient range of concentrations in the final processing stream will vary depending upon the particular system used, but varying the injection pressures between about 5 and about 50 PSIG, and preferably between about 14 PSIG and about 40 PSIG, is usually sufficient. One skilled in the art would recognize that there are various injection systems that would be capable of combining one or more process solutions with the carrier stream to form the processing stream.

A bleed valve is optionally provided for directing the processing stream to a drain line so that the carrier system can be rinsed with the process solutions. In operation, the processing stream maybe directed to the drain line by opening the bleed valve and closing the control valve. After a sufficient volume of the processing stream has passed through the bleed valve so that the carrier supply system is sufficiently rinsed, the control valve is opened and the bleed valve is closed to direct the processing stream into the process vessel.

The processing stream formed in accordance with the present invention may be used to treat semiconductor substrates in the process vessel 11. Examples of processing streams used to treat semiconductor substrates include cleaning solutions, etching solutions, or solutions to remove photoresists. These solutions contain one or more chemicals to achieve the desired treatment.

For example, cleaning solutions typically contain chemicals effective in removing particles, metal ions, or organics such as waxes, residual polish, or grease. Chemicals used for cleaning are typically corrosive agents, such as acids or bases. Suitable acids for cleaning include for example sulfuric acid, hydrochloric acid, nitric acid, or aqua regia. Suitable bases include for example, ammonium hydroxide. The desired concentration of the corrosive agent in the cleaning solution will depend upon the particular corrosive agent chosen and the desired amount of cleaning. These corrosive agents may also be used with oxidizing agents such as ozone or hydrogen peroxide.

Preferred cleaning solutions are “APM” solutions containing water, ammonia, and hydrogen peroxide, and “HPM” solutions containing water, hydrogen peroxide, and hydrochloric acid. Typical concentrations for APM solutions range from about 5:1:1 to about 200:1:1 parts by volume of water:H₂O₂:NH₄OH. Typical concentrations for HPM solutions range from about 5:1:1 to about 1000:0:1 parts by volume of water:H₂O₂:HCl.

Suitable etching solutions contain agents that are capable of removing oxides. A common etching agent used is for example hydrofluoric acid, hydrofluoric acid buffered with ammonium hydroxide, ammonium fluoride, or other substances that generate hydrofluoric acid in solution. A hydrofluoric acid containing etching solution may contain for example from about 4:1 to about 1000:1 parts by volume of water:HF. Solutions used to remove photoresists include for example solutions containing sulfuric acid, and an oxidizing substance such as hydrogen peroxide, ozone or combinations thereof.

In addition to processing streams used for treating semiconductor substrates, processing streams in accordance with the present invention can be used for rinsing. “Rinsing fluids” are fluids used to wet the semiconductor substrates in preparation for subsequent wet processing steps, remove previous processing streams, and/or remove other contaminants such as particles from the semiconductor substrates. In selecting a rinsing fluid, such factors as the nature of the surfaces of the semiconductor substrates to be rinsed, the nature of contaminants present on the semiconductor substrates, and the nature of the processing stream to be rinsed may be considered. Suitable rinsing fluids include those fluids previously described as being suitable for carrier streams, ozone, surfactants, or combinations thereof.

One skilled in the art will recognize that there are various processing streams that can be used during wet processing. Additional processing streams are disclosed in “Chemical Etching” by Werner Kern et al., in Thin Film Processes, edited by John L. Vosser et al., published by Academic Press, NY 1978, pages 401-496, which is incorporated by reference in its entirety.

The particular processing streams used, the sequence of the processing streams, the exposure time, and processing conditions (i.e., temperature, concentration, and flow rates) will vary depending on the particular purpose of the particular wet process. Additionally, other fluids (e.g., liquid, vapor, gas, or combinations thereof) may be contacted with the semiconductor substrates during wet processing.

The processor 13 used in accordance with the present invention comprises a receiver 35. The receiver 35 comprises any type of system capable of receiving data necessary for determining an injection rate associated with the injection system 12 suitable for mixing appropriate amounts of process solutions into the carrier stream at an appropriate rate. For example, the receiver 35 may receive carrier stream flow rates from the flow meters 20, injection pressures from the pressure gauges 32, injection control valve position data from the injection range valves 28 and/or control valves 29, and/or data reflecting the levels of the process solutions in the injection tubes 25 from the sensors 33.

In the embodiment of FIG. 1, the processor 13 also comprises a controller 37 for automatically controlling the injection and/or carrier supply systems, 12 and 10, respectively. In particular, the controller 37 functions to automatically adjust one or more of the injection pressures, the flow rate of the carrier stream, and/or the injection control valve positions. The controller 37 may be part of the processor 13 used to receive data (i.e., the receiver 35) or a separate control system.

Receivers 35 and controllers 37 suitable for use in the present invention include for example processors such as personal computers, programmable logic controllers (PLCs), or embedded processors. Preferred processors include PLCs, such as those manufactured by Allen Bradley.

In operation, the controller 37 of the processor 13 sends signals to control the injection pressures of the injection tubes 25, the opening and closing of the carrier stream control valve 19, and/or the positions of the injection control valves 28. For example, the receiver 35 can monitor the measured flow rate of the carrier fluid flowing out of the carrier supply system 10 via flow meters 20. As explained below, based on prior calibration data relating to the amount of chemical process solution sent through injection lines 24 for a given applied pressure via pressure regulator 31 and for a defined range valve 28 setting (control valve 29 being open), the processor 13 can compute, based on the measured carrier fluid flow rate and a desired final chemical solution level for the carrier fluid to be sent into the processing vessel 11, the setting to be chosen for pressure regulator 31 to apply the correct pressure to the injection tubes 25. By applying this correct pressure through pressure regulator 31, the correct amount of the chemical solution is sent through line 24 into line 30.

As mentioned, in one embodiment the processor 13 is calibrated prior to use. The calibration process is used to generate a set of data for each of the process solutions that relates the flow rate of the process solution into the processing stream with the injection pressures, the carrier stream flow rate, and/or the injection control valve positions. The generated data is then used to determine the injection pressures, the carrier stream flow rate, and/or the injection control valve positions required to provide a processing stream having a predetermined concentration of one or more process chemicals.

The processor 13 is used to calibrate the injection system by selecting a set of calibration parameters that includes the carrier stream to be utilized; a range for the carrier stream flow rate; the set of injection tubes 25 to be used; the range of injection valve positions for each injection tube 25; and the pressure range to be used for each of the injection tubes 25.

Once the calibration parameters have been selected, a set of data is generated for each of the process solutions that relates the injection rates of the selected process solutions with the corresponding injection pressures, the carrier stream flow rates, and/or the injection control valve positions. Toward that end, each of the selected injection tubes 25 is filled with the appropriate process solution. Generally, for a given carrier stream flow rate and injection valve position, the dependence of delivered concentration on injection pressure is preferably able to be determined using a single injection of a full 4 inch (10 cm) injection tube. The processor 13 is then operated to control the injection pressures of the selected injection tubes 25, the carrier stream flow rate, and/or the injection control valve positions associated with the selected injection tubes 25. It will be appreciated that the sequence in which the processor 13 controls the injection pressures, the carrier stream flow rate, and the injection control valve positions can be varied depending upon the specific application for which the system will be used. For example, in one embodiment, the processor 13 is used to simultaneously calibrate each of the selected injection tubes 25 by varying the injection pressures (either stepwise or continually) of each of the selected injection tubes 25 while keeping the carrier stream flow rate and the positions of the injection control valves 28 unchanged. However, since the minimum stable injection pressure may vary as a function of carrier stream flow rate and because the injection rate changes as a function of applied pressure, the procedure is preferably repeated for three or more different carrier stream flow rates. The number of carrier stream flow rates needed is optionally minimized using an adaptive algorithm. For example, each of the selected injection tubes 25 is calibrated at a low flow rate (e.g., 5 gpm) and at a high flow rate (e.g., 20 gpm). Estimated injection rates for the mid-point (e.g., 12.5 gpm) are calculated by interpolating the measured high and low flow rates. The actual injection rates at the mid-point are measured and compared to the estimated flow rates. If the differences between the actual and estimated injection rates at the mid-point are less than a predetermined value, then calibration at other flow rates is unnecessary. If, however, the difference between the actual and estimated injection rates is unacceptably large, actual injection rates are measured for intermediate flow rates and analyzed in the same manner as just described. Alternatively, a particular carrier stream flow rate and injection control valve position are utilized while the injection pressures are varied sequentially for each of the selected injection tubes 25. In yet another embodiment, the injection pressures and carrier stream flow rate are varied, while the injection control valve positions remain the same. With this embodiment, as above, the selected injection tubes 25 can be calibrated either simultaneously or sequentially. In still another embodiment, the injection pressures, the carrier stream flow rate, and the injection control valve positions are all varied.

Control of the injection pressures and the carrier stream flow rate allows the systems and methods of the present invention to access a wide range of process chemical concentrations in the processing stream. It will be recognized that control of the injection pressures, the carrier stream flow rate, and the injection control valve positions allows access to the entire dynamic range of possible process chemical concentrations. Typically, for example in the case of the CFM Full-Flow™-type system, a dynamic concentration range of about 2.5-to-1 is available by using fixed injection control valve positions and a fixed carrier stream flow rate (i.e., varying only the injection pressures). If the carrier stream flow rate is also varied, then the dynamic concentration range can be increased to about 25-to-1. However, certain applications may place inherent restrictions on the ability to vary one or more of the injection pressures, the carrier stream flow rate, and the injection control valve positions. For example, when hydrogen fluoride (HF) is used to etch semiconductor substrates, only the injection pressures and injection control valve positions may be varied due to the critical effect of carrier stream flow rate and the resulting fluid dynamics within the processing vessel on etch uniformity.

Throughout the injection period, the levels of the process solutions in the selected injection tubes 25, the corresponding injection pressures, the carrier flow rate, and/or the corresponding injection control valve positions are measured and recorded as a function of time by the receiver 35 of the processor 13. If the backpressure induced by the carrier stream flow is separately characterized, the number of injections necessary to reliably calibrate an injection tube is reduced.

The recorded data is then used by the processor 13 to generate the set of data that relates the flow rate of each of the selected process solutions with the corresponding injection pressures, the carrier stream flow rate, and/or the corresponding injection control valve positions. In one embodiment, discrete values for the volume of process solution injected at specific times “t” (V(t)) are determined from the recorded level and time measurements using the equation: V(t)=πr² (ΔL), where r is the radius of the injection tube and ΔL is the change in the level of the process solution in the injection tube. The discrete values for V(t) are then regressed to obtain an equation for the volume as a function of time. For example, the values for V(t) can be fit to a cubic equation having the form: V(t)=At³+Bt²+Ct+D, where A, B, C, and D are constants. The volume equation is then differentiated to obtain an equation for the injection rate as a function of time (R(t)). When the volume equation is cubic, the injection rate is given by the equation: R(t)=3At²+2Bt+C. The rate equation, together with the measured data for the injection pressures as a function of time is then used to determine the injection rates at each injection pressure for each of the selected process solutions. In one embodiment, the data is regressed to provide a calibration equation wherein carrier stream flow rate, injection pressure, and injection control valve position are independent variables and chemical concentration is the dependent variable. The correlation coefficient is optionally determined and the correlation equation rejected if the correlation coefficient is below a predetermined value (e.g., below about 0.9). Further, since the calibration equation is not an exact inverse of the rate equation, the range of injection rates for which the calibration equation is valid is optionally determined. The range of injection rates for which the calibration equation is valid is determined using the starting and ending injection pressures to obtain approximate values for the minimum and maximum injection rates, and then utilizing the minimum and maximum injection rates to determine the minimum and maximum pressures. Alternatively, a multi-dimensional table of information is generated for each of the selected process solutions wherein carrier stream flow rate, injection pressure, and injection control valve position are independent variables and chemical concentration is the dependent variable. The measured injection pressures are optionally adjusted prior to use to correct for the weight of the column of process solution within the injection tubes 25 (i.e., the injection pressures are increased by the weight of the column of the process solution to provide the effective pressure that would be used if the injection tube 25 was empty). Adjusting the measured injection pressures enables the processor 13 to begin an injection at any column height.

The calibration equation itself or the multi-dimensional table of information that relate the flow rates of the selected process solutions with the injection pressures, the carrier stream flow rate, and/or the injection control valve position is then used to determine the injection pressures required to obtain the desired injection rates at a given carrier stream flow rate and/or injection control valve positions. For example, the required injection pressure can be determined by interpolating between discrete data points within the set of data. Alternatively, the set of data can be regressed using, for example, a multi-variable equation and the required injection pressure determined from the regression equation. The required injection pressures, carrier stream flow rates, and/or injection control valve positions are then utilized by the controller 37 of the processor 13 to manipulate the injection pressures, carrier stream flow rate, and/or injection control valve positions to form the desired processing streams.

The processing stream, once formed from the appropriate process solutions and carrier stream, is directed into the processing vessel 11 to contact the semiconductor substrates for a predetermined exposure time. The processing stream can be directed through the processing vessel 11 by any of a variety of conventional means. Preferably, the processing stream is directed through the process vessel 11 so that the parts of the semiconductor substrates first exposed to the processing stream are the first parts of the semiconductor substrates removed from the processing stream. This “first in-first out” method can be achieved, for example, by directing the processing stream into the process vessel 11 through a valve 42 operatively connected to a first port 44 at the bottom of the process vessel 11, and draining the processing stream from the process vessel through a second port 46 positioned at the top of the process vessel 11. Preferably, the processing stream is drained from the process vessel 11 through a valve 48 connected between the second port and a drain line 49. It will be appreciated, however, that the processing stream could be directed in various other ways. For example, the processing stream could be directed into the process vessel 11 through the second port 46 and drained from the process vessel 11 through the first port 44. Feeding from the second port to the first port is particularly preferred when drying the semiconductor substrates with a drying fluid. Alternatively, the processing stream can be directed into the process vessel 11 and drained therefrom through the same port.

Removal of the processing stream from the process vessel 11 can be performed in any of a variety of conventional means. For example, a rinsing fluid, drying fluid or a second processing stream could be directed through the process vessel to displace the processing stream currently in the vessel 11 either through the first or second ports. When a second processing solution is used, the second processing solution is preferably formed in the manner described above.

An example of a suitable wet processing sequence includes contacting the semiconductor substrates with an APM (Ammonia Peroxide Mixture) solution (such as a solution of 80:3:1 parts by volume of water: hydrogen peroxide: ammonium hydroxide), or an HPM (Hydrochloric Peroxide Mixture) solution (such as a solution of 80:1:1 parts by volume of water: hydrogen peroxide: hydrochloric acid), rinsing with deionized water, contacting the semiconductor substrates with an etching solution (such as hydrofluoric acid solution), and rinsing with deionized water. Preferably, the last wet processing step prior to drying is a rinse step. Thus there are various ways in which the semiconductor substrates could be wet processed in accordance with the present invention. One skilled in the art would recognize that the methods of the present invention may be applied to other types of wet processing steps where chemical concentrations need to be monitored.

Following wet processing with at least one wet processing solution, the semiconductor substrates are preferably dried. By “dry” or “drying” it is meant that the semiconductor substrates are preferably made substantially free of liquid droplets. By removing liquid droplets during drying, impurities present in the liquid droplets do not remain on the surfaces of the semiconductor substrates when the liquid droplets evaporate. Such impurities undesirably leave marks (e.g., watermarks) or other residues on the surfaces of the semiconductor substrates. However, it is also contemplated that drying may simply involve removing a processing stream or rinsing fluid, for example, with the aid of a drying fluid.

Any method and system of drying may be used. Suitable methods of drying include, for example, evaporation, the use of centrifugal force in a spin-rinser-dryer, steam, chemical drying, or combinations thereof

A preferred method of drying uses a drying fluid to directly displace the last fluid that the semiconductor substrates are contacted with prior to drying (hereinafter referred to as “direct displace drying”). Suitable methods and systems for direct displace drying are disclosed in for example U.S. Pat. Nos. 4,778,532; 4,795,497; 4,911,761; 4,984,597; and 5,569,330, the disclosures of which are incorporated herein in their entireties. Other direct displace dryers that can be used include Marangoni type dryers supplied by manufacturers such as Steag, Dainippon, and YieldUp. Most preferably, the system and method of U.S. Pat. No. 4,7911,761, the disclosure of which is incorporated herein in its entirety, is used for drying the semiconductor substrates.

Preferably, the drying fluid is formed from a partially or completely vaporized drying solution. The drying fluid may be, for example, superheated, a mixture of vapor and liquid, or saturated vapor. Examples of drying solutions which may be employed are steam, alcohols such as methanol, ethanol, 1-propanol, isopropanol, n-butanol, secbutanol, tertbutanol, or tert-amyl alcohol, acetone, acetonitrile, hexafluoroacetone, nitromethane, acetic acid, propionic acid, ethylene glycol mono-methyl ether, difluoroethane, ethyl acetate, isopropyl acetate, 1,1,2-trichloro-1,2,2-trifluoroethane, 1,2-dichloroethane, trichloroethane, perfluoro-2-butyltetrahydrofuran, perfluoro- 1 ,4-dimethylcyclohexane or combinations thereof. Preferably, the drying solution is a C₁ to C₆ alcohol, such as for example methanol, ethanol, 1-propanol, isopropanol, n-butanol, secbutanol, tertbutanol, tert-amyl alcohol, pentanol, hexanol or combinations thereof.

### EXAMPLES

A system in accordance with the present invention was calibrated to form a processing stream having deionized (DI) water as the carrier stream and hydrogen peroxide (H₂O₂) as the only process chemical. In particular, a Full Flow Omni 8100 Type system, available from CFM Technologies, Inc.) was calibrated in accordance with the present invention. The flow rate of the deionized water carrier stream was maintained at 13 GPM and the position of the injection control valve remained fixed. The injection pressure was continuously varied from a minimum value of 14 PSIG to a maximum value of 30 PSIG.

Representative measurements of the level of hydrogen peroxide in the injection tube as a percent (LevelInPercent) for representative times in arbitrary units (MeasurementTime) is given in Table 1. The conversion for the measured time in arbitrary units to time in minutes (Time) is also provided in Table 1. The volume of hydrogen peroxide injected (Volume) in gallons was determined from the level in percent and is shown in Table 1.

TABLE 1

| MeasurementTime | LevelInPercent | Time(minutes) | Volume(gallons) |
|---|---|---|---|
| 10764 | 92.2 | 0.1794 | 0.57164 |
| 14936 | 89.7 | 0.248933333 | 0.56614 |
| 18218 | 87.8 | 0.303633333 | 0.54436 |
| 21233 | 86.1 | 0.353883333 | 0.53382 |
| 24718 | 84 | 0.411966667 | 0.5208 |
| 28186 | 81.6 | 0.469766667 | 0.50692 |
| 31546 | 79.5 | 0.525766667 | 0.4929 |
| 35061 | 77.3 | 0.58435 | 0.47926 |
| 38905 | 74.7 | 0.648416667 | 0.46314 |
| 42186 | 72.5 | 0.7031 | 0.4495 |
| 45389 | 70.5 | 0.756483333 | 0.4371 |
| 48952 | 67.8 | 0.815866667 | 0.42036 |
| 52593 | 65.4 | 0.87655 | 0.40548 |
| 56218 | 62.8 | 0.936966667 | 0.38936 |
| 59686 | 60.5 | 0.994766667 | 0.3751 |
| 62952 | 57.7 | 1.0492 | 0.35774 |
| 66421 | 55.1 | 1.107016667 | 0.34162 |
| 69983 | 52.5 | 1.166383333 | 0.3255 |
| 73671 | 49.8 | 1.22785 | 0.30876 |
| 77077 | 46.9 | 1.284616667 | 0.29078 |
| 80280 | 44.5 | 1.338 | 0.2759 |
| 83968 | 41.4 | 1.399466667 | 0.25668 |
| 87233 | 38.9 | 1.453883333 | 0.24118 |
| 91124 | 35.6 | 1.518733333 | 0.22072 |
| 95124 | 32.1 | 1.5854 | 0.19902 |
| 98952 | 28.9 | 1.6492 | 0.17918 |
| 102421 | 26.2 | 1.707016667 | 0.16244 |
| 105905 | 23.1 | 1.765083333 | 0.14322 |
| 109327 | 20.2 | 1.822116667 | 0.12524 |
| 112624 | 17.5 | 1.877066667 | 0.1085 |
| 116218 | 14.5 | 1.936966667 | 0.0899 |

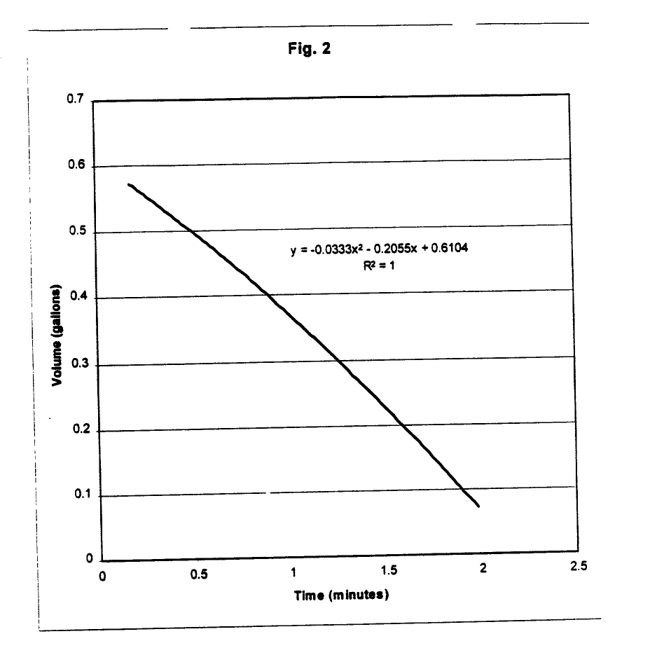

FIG. 2 shows a graph of the volume equation as a function of time obtained using the volumes of hydrogen peroxide injected as a function of time shown in Table 1. The level measurements were fit to a quadratic equation of the form V(t)=−0.0333t²−0.2055t+0.60104 with a regression coefficient (R²) of 1. Taking the derivative gives a rate equation of the form R(t)=2(−0.0333t)−0.2055.

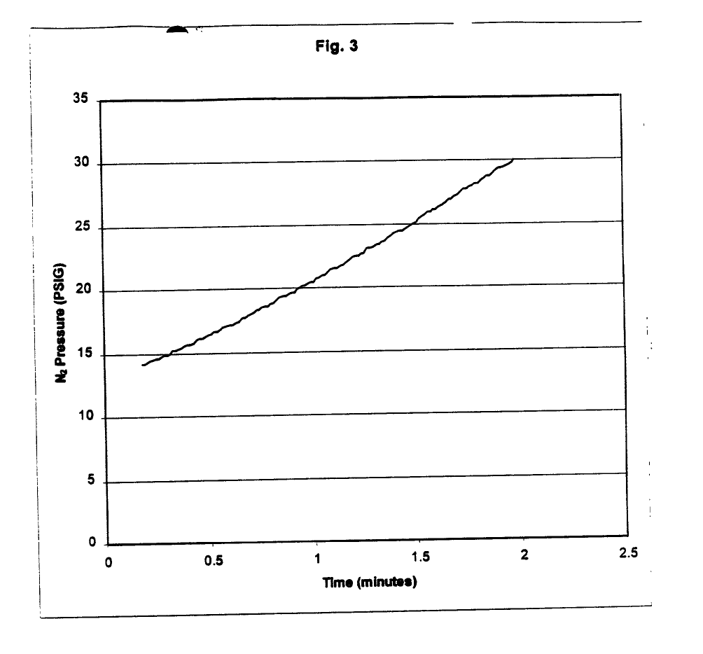

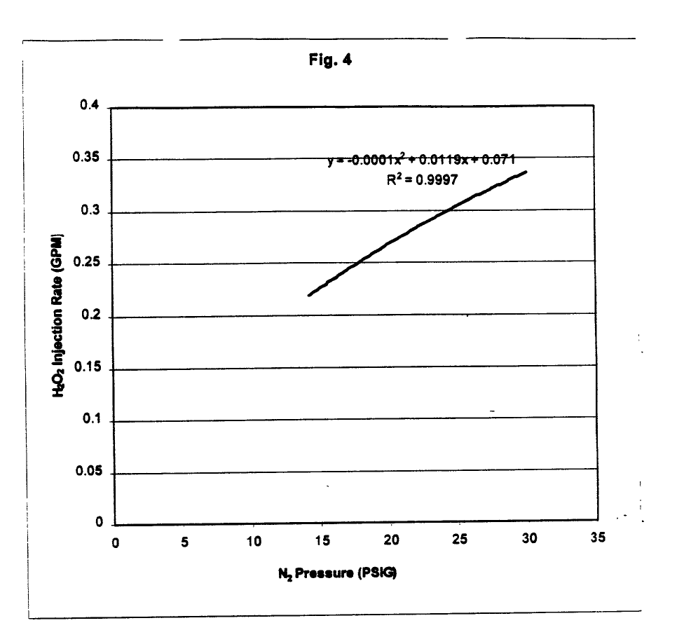

The measured values of the injection pressure as a function of time are plotted in FIG. 3. The data of FIGS. 2 and 3 were combined to obtain the hydrogen peroxide injection rate as a function of the injection pressure. The data relating injection rate to injection pressure was fit to a quadratic equation of the form R(t)=−0.0001P²+0.0119P+0.071, where P is the injection pressure, with a regression coefficient (R²) of 0.9997. The results are plotted in FIG. 4.

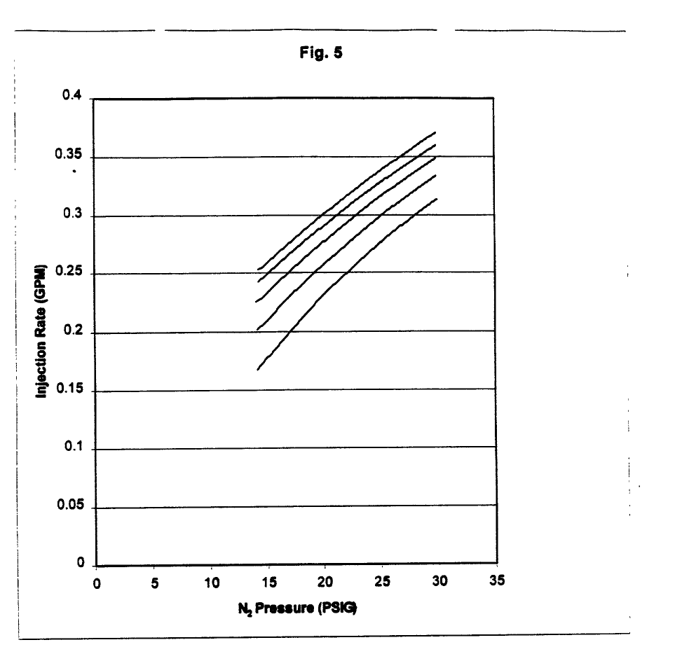

The effect of changing the deionized water carrier stream flow rate was determined by repeating the above procedure using flow rates of 5, 9, 17, and 21 GPM. The results are shown in FIG. 5.

Those skilled in the art will appreciate that numerous changes and modifications may be made to the preferred embodiments of the invention and that such changes and modifications may be made without departing from the spirit of the invention. It is therefore intended that the appended claims cover all equivalent variations as fall within the true scope and spirit of the invention.

What is claimed is:

1. A system for processing electronic components comprising:
a. a vessel for holding electronic components;
b. a carrier supply system in fluid communication with the vessel for supplying a carrier stream to the vessel;
C. an injection system in fluid communication with the carrier supply system for introducing a process solution into the carrier supply system at a location upstream from the vessel; and
d. a processor operatively associated with the injection system for:
i. generating data for process solution volume and injection pressure associated with the injection system and carrier stream flow rate associated with the carrier supply system as a function of time;
ii. determining a process solution injection rate as a function of injection pressure and carrier stream flow rate;
iii. determining values for the injection pressure and the carrier stream flow rate for a predetermined process solution injection rate; and
iv. injecting the process solution from the injection system into the carrier supply system at the predetermined process solution injection rate by adjusting the injection pressure and the carrier stream flow rate to the determined values.

2. The system of claim 1 wherein the injection system comprises an injection tube.

3. The system of claim 2 wherein the injection system comprises a plurality of injection tubes for introducing a plurality of process solutions into the carrier supply system.

4. The system of claim 3 wherein the processor is operatively associated with one or more of the plurality of injection tubes for individually adjusting an injection rate associated with one or more of the plurality of injection tubes.

5. The system of claim 1 wherein the injection system comprises a reservoir for containing a process solution, an outlet operatively connected between the reservoir and the carrier supply system for establishing fluid communication between the reservoir and the carrier supply system, and a valve positioned between the outlet and the carrier supply system.

6. The system of claim 5 wherein the processor is operatively associated with the valve for adjusting the valve.

7. The system of claim 1 wherein the processor adjusts the injection rate associated with the injection system based on one or more predetermined calibration parameters.

8. The system of claim 7 wherein the injection system comprises an injection tube.

9. A method for preparing a chemical solution containing a carrier fluid and at least one process solution for processing electronic components comprising the steps of:
a. generating data for process solution volume and injection pressure associated with an injection system and carrier fluid flow rate associated with a carrier supply system as a function of time;
b. determining a process solution injection rate as a function of injection pressure and carrier fluid flow rate;
c. determining values for the injection pressure and the carrier fluid flow rate for a predetermined process solution injection rate; and
d. injecting the process solution from the injection system into the carrier fluid at the predetermined process solution injection rate by adjusting the injection pressure and the carrier fluid flow rate to the determined values.

10. The method of claim 9 wherein the carrier stream flow rate is maintained at a substantially constant rate.

11. A method for preparing a chemical process solution comprising a carrier fluid and at least one process solution for processing electronic components comprising the steps of:
a. generating data for process solution volume, process solution injection pressure, and injection range valve position associated with an injection system and carrier fluid flow rate associated with a carrier fluid supply system as a function of time;
b. determining a process solution injection rate as a function of process solution injection pressure, injection range valve position and carrier fluid flow rate;
c. determining values for the process solution injection pressure, the injection range valve position and the carrier fluid flow rate for a predetermined process solution injection rate; and
d. injecting the process solution from the injection system into the carrier fluid at the predetermined process solution injection rate by adjusting the process solution injection pressure, the injection range valve position and the carrier fluid flow rate to the determined values.

12. The method of claim 11 wherein the injection range valve position is maintained at a substantially fixed position.

13. A method for preparing a chemical process solution containing a carrier fluid and at least one process solution to be used for processing electronic components comprising the steps of:
a. providing a process solution injection system comprising at least one injection conduit comprising (i) a pressurizable process solution reservoir containing a process solution and (ii) an injection range valve located downstream from the reservoir;
b. providing a carrier fluid supply system comprising a carrier fluid conduit for transporting a carrier fluid, wherein the carrier fluid conduit is in fluid communication with the injection conduit at a location downstream from the injection range valve;
c. generating calibration data for the flow rate of the process solution through the injection conduit, the pressure applied to the process solution in the process solution reservoir, the position of the process solution injection range valve and the flow rate of the carrier fluid; and
d. subsequently, preparing a chemical process solution containing the carrier fluid and at least one process solution by adjusting at least one of the flow rate of the carrier fluid, the pressure applied to the process solution reservoir, and the setting of the injection range valve position in response to the calibration step.

14. The method of claim 13 wherein the chemical process solution is prepared by setting the injection range valve position, monitoring the flow rate of the carrier fluid, and adjusting the pressure applied to the process solution reservoir in response to the flow rate of the carrier fluid.
